(19) United States
(12) Patent Application Publication
(10) Pub. No.: US 2018/0009309 A1
(43) Pub. Date: Jan. 11, 2018

(54) HYBRID DRIVE TRAIN

(71) Applicant: DEUTZ Aktiengesellschaft, Koeln (DE)

(72) Inventors: Thorsten Maringer, Bergisch-Gladbach (DE); Marco Brun, Langenfeld (DE)

(21) Appl. No.: 15/547,284

(22) PCT Filed: Feb. 19, 2016
(86) PCT No.: PCT/EP2016/000290

§ 371 Date: Jul. 28, 2017

(30) Foreign Application Priority Data
Feb. 23, 2015 (DE) 10 2015 002 111.7

(51) Int. Cl. B60K 6/485; B60W 20/00; B60W 10/06; B60W 10/08; B60W 30/188; F15B 13/04; F15B 11/08

(52) U.S. Cl. CPC B60K 6/485; B60W 10/08; B60W 20/00; B60W 30/1882; B60W 30/1886; B60W 10/06; B60W 2710/081; B60W 2710/0644; B60W 2510/081; B60W 2510/0638; B60W 2300/17; B60Y 2200/41; B60Y 2400/20; F15B 11/08; F15B 13/0401; Y10S 903/93; F15B 2211/7051

(57) ABSTRACT

A parallel hybrid drive train, in particular for a working machine, includes an internal combustion engine (1), an electrical machine (2) and hydraulic aggregates (3, 4, 5, 9) for driving working devices (6-8) and for moving the working machine. In order to increase the efficiency, the rotational speed of the internal combustion engine is lowered, that is to say the load point is moved. Increased power requirements are detected via a driver input and provide a desired rotational speed. The electrical machine assists the acceleration of the internal combustion engine to said desired rotational speed.

The present invention relates to a hybrid drive train of a vehicle, in particular a mobile working machine, including an internal combustion engine and an electric machine.

### BACKGROUND

A hybrid drive train of this type is known from ATZ 7-8/2002, pages 664 through 674. The electric machine is interconnected with the internal combustion engine and a hydraulic pump.

Construction machines are usually operated at high constant nominal rotational speeds of the internal combustion engine during their working phases to be able to provide the maximum system power at any time during highly dynamic load peaks. Moreover, a speed droop is usually set in the engine control unit, which further increases the working rotational speed if the maximum capacity utilization of the internal combustion engine fails to be reached. If the load is higher than the maximum capacity utilization of the internal combustion engine, so that the internal combustion engine is strained or is even about to stall, a limit load regulation generally engages, which reduces the load on the internal combustion engine at the expense of the work to be performed by the construction machine to the extent that the nominal rotational speed may be kept stationary.

A high nominal rotational speed is thus set throughout the entire working phase, which, however, is only really needed during load peaks. In the remaining ranges, a lower nominal rotational speed of the internal combustion engine would be sufficient to provide the power being requested. Reducing the nominal rotational speed has a significant influence on the reduction in the fuel consumption of the internal combustion engine and thus on the reduction of carbon dioxide emissions (lower greenhouse effect, less environmental pollution).

If one were to keep the nominal rotational speed as low as necessary and increase it by the necessary degree only during corresponding load phases, which are requested very dynamically, the internal combustion engine would often not manage to increase the nominal rotational speed on its own so dynamically that the requested power may be provided to the same extent as would be the case with a continuously high nominal rotational speed.

In this case, while the internal combustion engine tries to accelerate to the new, higher nominal rotational speed, the instantaneous load present at the internal combustion engine counteracts the acceleration and may even readily result in the fact that the rotational speed decreases instead of increasing, because the internal combustion engine is unable to build up the necessary torque quickly enough.

### SUMMARY OF THE INVENTION

An object of the present disclosure is to develop a method for increasing the torque of the entire drive train during acceleration phases of the internal combustion engine from a lower rotational speed to a higher rotational speed, with the aid of which the nominal rotational speed may be dynamically regulated in construction machines during the working phases without suffering losses at dynamic load peaks. For this purpose, the system must be able to accelerate highly dynamically from lower to higher nominal rotational speeds even in the case of highly dynamic load demands. The nominal rotational speed in construction machines may thus be maintained over long ranges at a preferably low and efficient rotational speed with respect to the fuel consumption.

An object of the present invention is also to improve a hybrid drive train of a vehicle.

The drive train includes a hydraulic working machine.

According to one or more embodiments of the present invention, the following advantages are achieved:

Saving fuel by increasing the average capacity utilization of the internal combustion engine, higher torque at lower rotational speeds;
Improving the dynamic characteristics of the drive.

The illustrated embodiment implements the electric machine as an integrated starter and generator, a torque assistance of the internal combustion engine taking place in such a way that a high torque is available for a short period of time (<1 second).

### Arrangement of Components

The conventional drive train of a mobile working machine, which includes an internal combustion engine and hydraulic drive units, is expanded to include an electric machine, situated in parallel, which spatially takes the place of the flywheel. The electric machine is supplied from an electrical energy store via a power electronics system and may be operated in all four quadrants.

This diesel-electric hybrid is operated in a rotational speed-regulated manner in the indicated arrangement. This means that the driver's request is interpreted as a setpoint rotational speed. This operating mode has become established, in particular, in the area of mobile working machines. The diesel-electric hybrid is also to adjust the rotational speed desired by the equipment operator in the case of changing loads, in that the torque generated by the diesel-electric hybrid is adapted accordingly. The load is generated by the working hydraulics, the drive load and other outputs.

In contrast to the conventional drive, the internal combustion engine (ICE) is not started via a separate starter motor but directly via the electric machine. Unlike in the known drive train, the internal combustion engine may be started within a very short period of time, which is in a range around or below 200 milliseconds. In this way, the internal combustion engine may be operated in automatic start/stop mode.

The start/stop mode causes the internal combustion engine to be operated only when it is actually needed. If the internal combustion engine is in low idle mode for a particular period of time, it is turned off by the system on request.

If the equipment operator actuates an operating component, the internal combustion engine is immediately restarted, so that the operator notices practically no delay. The operating components may be the accelerator pedal, the steering system, the activation unit of the working hydraulics or the joystick.

This function results in fuel savings by avoiding unnecessary idle times.

At suitable operating points, the electric machine is motor-operated to increase the torque of the entire drive.

The required torque, which is needed to maintain the rotational speed desired by the equipment operator, is calculated by a control algorithm and converted by the power electronics. The system takes into account all states relevant in the system, for example the charge state of the energy store, temperatures of individual components, etc.

The nominal rotational speed is the desired rotational speed of the internal combustion engine at full load.

The working rotational speed is the instantaneously set rotational speed, taking into account the speed droop. The working phases are phases in which the construction machine is being used for work, i.e., the internal combustion engine is under load. In phases in which no work is being done with the aid of the construction machine, the nominal rotational speed is usually set to low idle speed.

This function of dynamic rotational speed reduction makes it possible to use an internal combustion engine at a lower rotational speed. The power remains the same and is requested by the operator. The rotational speed is reduced, while the torque of the internal combustion engine increases accordingly.

Power=torque×rotational speed.

Short-term peak powers may be covered by assisting the motor-driven electric machine, so that the internal combustion engine no longer has to be configured for the necessary/desired peak power. The peak powers that are already requested in any case at high nominal rotational speeds (e.g. 2,000 rpm) must preferably continue to be provided by the internal combustion engine. Only additional power peaks which occur during the acceleration phases are added here.

These precise power outputs may generally not be provided fast enough by the internal combustion engine, since the rotational speed is too low and the torque is unable to be provided quickly enough by the internal combustion engine alone.

In addition to boosting while covering the power peaks, it is possible to use the motor-driven operation of the electric machine to increase the dynamics of the drive train.

If the injection quantity of the internal combustion engine, in particular, is limited to a value below the top curve by the boost pressure-dependent fill limitation, a motor-driven power of the electric machine may continue to be provided to increase the dynamics until this limitation is no longer necessary due to sufficient boost pressure.

The electrical energy store is charged by generating a generator torque of the electric machine during operation. The generated torque is dependent on the charge state of the energy store, the capacity utilization of the internal combustion engine and various system conditions. The torque may be applied as a manipulated variable of a controller, or it may be controlled.

Recuperation is generally understood to be the recovery of the mechanical braking energy into electrical energy.

In conventional mobile working machines, almost the entire portion of the braking energy is reached by the overrun mode of the internal combustion engine at high rotational speeds and by the targeted application of hydraulic loads.

In this configuration of a hybrid drive, the braking energy is achieved by applying a braking torque to the electric machine. On the one hand, the high motor rotational speeds are avoided hereby, and on the other hand, the braking energy is fed into the electrical energy store via the electric machine and the power electronics.

In hybrid drive trains of mobile working machines, including components according to the one or more embodiments of present invention: internal combustion engine (diesel engine), electric machine including converter, electrical energy store and hydraulic traction and working drive, the function of load point shifting, among other things, is used to reduce CO₂ emissions and fuel consumption.

With the aid of this function, the particular working points in the characteristic map of the internal combustion engine (torque as a function of rotational speed) are shifted along the curves of constant power (power hyperbolas) to shift the working points of the internal combustion engine into the areas of the particular optimum fuel consumption.

During the load point shift, the optimum setpoint rotational speed is ascertained by the hybrid control unit, among other things as a function of the parameters of instantaneous torque of the internal combustion engine, instantaneous torque of the electric machine, charge state of the energy store and instantaneous rotational speed of the internal combustion engine and electric machine, with the aid of an operating strategy implemented in the hybrid control unit, and transferred as a setpoint value to the downstream rotational speed controller.

The optimum setpoint rotational speed is ascertained on the basis of the information from the HMI interfaces (human-machine interfaces). The charge state of the energy store, for example, does not play a role.

The rotational speed controller of the internal combustion engine remains situated in the engine control unit. The rotational speed default, i.e. the setpoint rotational speed, is ascertained in the hybrid control unit.

The internal combustion engine is rotational speed-regulated. The electric machine is torque-regulated. The setpoint torque is calculated from the rotational speed difference (see position (4) in FIG. 5).

The use of the load point shift function in a hybrid drive has the following advantages over conventional drive trains of mobile working machines:
In a conventional drive, a high power reserve is maintained, due to the highly dynamic load changes of the traction or working drive during the operation of the internal combustion engine, to be able to adequately respond to load changes. In supercharged internal combustion engines, in particular, this power reserve is necessary to reduce the time duration of the boost pressure buildup. In the hybrid drive train, it is possible to significantly reduce this power reserve of the internal combustion engine. In dynamic load changes, a motor-driven power of the electric machine is applied until the internal combustion engine is in a working point, in which it is able to independently provide the requested power. This strategy is promoted, in particular, by the fast actuating capability of the torque of the electric machine.
The load point shift in conventional drives toward lower rotational speeds and thus higher torques is possible at most up to the rotational speed of the internal combustion engine, at which it applies the maximum torque. This is due to the fact that a load change at rotational speeds below the rotational speed of the maximum torque quickly causes or may cause the internal combustion engine to stall. In hybrid drive trains, a motor-driven power of the electric machine is again used to shift the internal combustion engine into a working point, in which it may independently provide the power.

### BRIEF SUMMARY OF THE DRAWINGS

Other advantageous embodiments of the present invention are apparent from the description of the drawings, which describes in greater detail an exemplary embodiment of the present invention illustrated in the figures.

FIG. 1 shows a schematic view of the arrangement and the interaction of the individual components;

FIG. 2 shows a characteristic map of the function of the load point shift with effect on the specific consumption (shell diagram);

FIG. 3 shows a characteristic map of the “load point shift” function;

FIG. 4 shows a system topology of a mild hybrid system of a construction machine, including an example of an electric machine and energy store;

FIG. 5 shows a schematic diagram for ascertaining the setpoint rotational speed of the internal combustion engine, including a dynamic rotational speed reduction and setpoint torque of the electric machine.

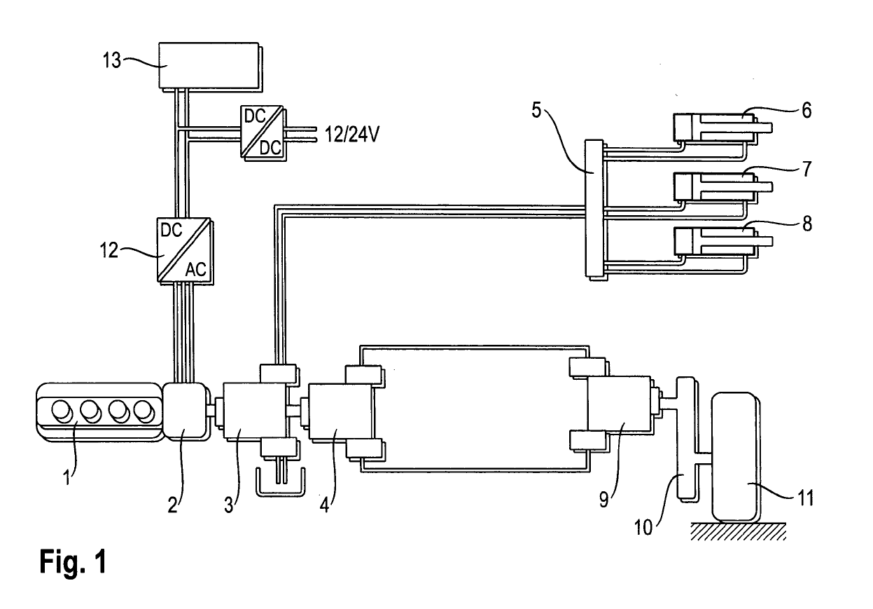

### DETAILED DESCRIPTION

An internal combustion engine 1, in particular, a self-ignition combustion engine (diesel engine), is coupled directly with an electric machine 2, which is interconnected with the crankshaft of internal combustion engine 1 in place of a flywheel. The stator of this electric machine 2 is connected to the crankcase, and the rotor is interconnected with the crankshaft. The rotor is furthermore interconnected with a gear pump 3 and also with an axial piston pump 4. The output of gear pump 3 is interconnected (for example) with a working cylinder 6, a lifting cylinder 7 and a steering cylinder 8 via proportional valves 5. Gear pump 3 and axial piston pump 4 are hydraulic working machines.

Electric machine 2 is interconnected with an electrical energy store 13 via a four quadrant converter 12. A hybrid control unit 21 is also provided, with the aid of which all individual control units of the components, in particular of the drive train and the storage train, may be coordinated.

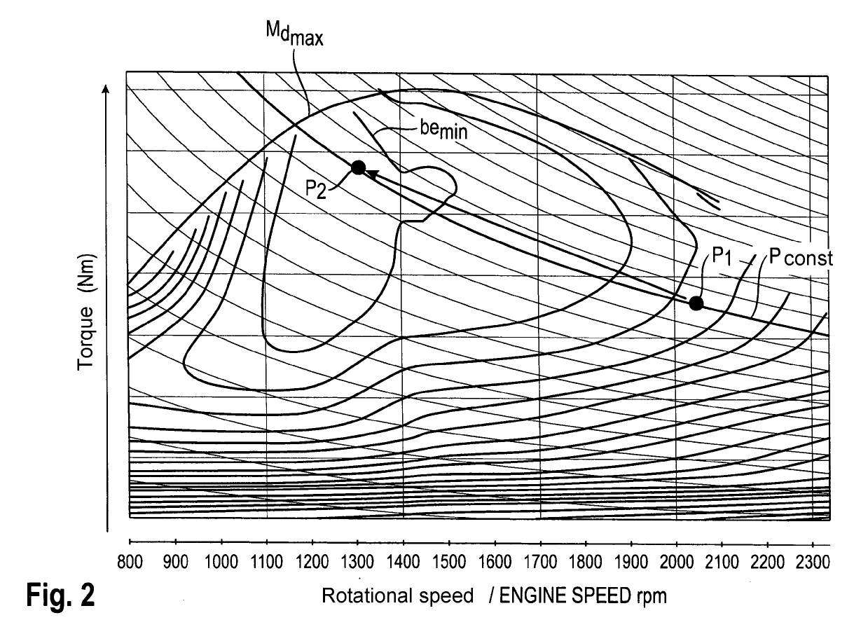

FIG. 2 shows a typical characteristic map of an internal combustion engine (torque as a function of rotational speed). In this characteristic map, the maximum torque Mdₘₐₓ reachable by the internal combustion engine is plotted as the top curve. The lines of constant specific (fuel) consumption are displayed as shell curves below this top curve, the remaining lines characterizing a gradually increasing consumption, starting from the beₘᵢₙ line. Finally, the curves of constant power Pₖₒₙₛₜ (power hyperbolas) of the internal combustion engine are plotted. In principle, the internal combustion engine, which is operated at a constant power Pₖₒₙₛₜ at point P1, may now be operated at the same constant power Pₖₒₙₛₜ at point P2, point P2, however, being situated in the beₘᵢₙ field. Due to this adjustment, a consumption reduction of the internal combustion engine is achieved at the same power output.

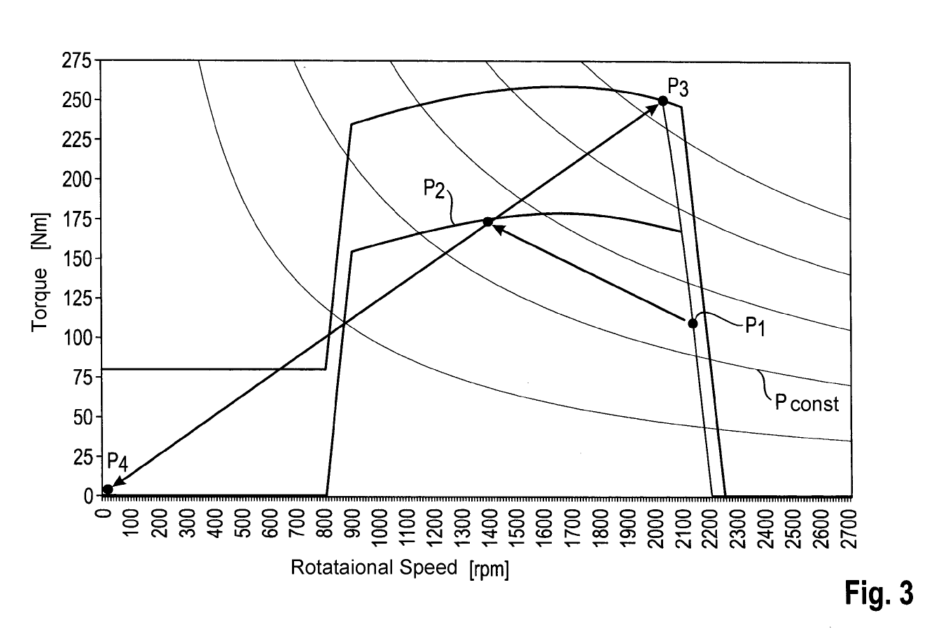

In conventional drive trains of this type, however, it is problematic that, in an adjustment of this type—as shown in FIG. 3—the latter is always associated with an approach to the top curve of the reachable maximum torque. As illustrated in FIG. 3, if the top curve is approached at power point P2 during the adjustment, the internal combustion engine no longer has any more power reserves even at low load changes, and the internal combustion engine stalls, as shown at point 4. A profile having a dynamic rotational speed reduction but without assistance from the electric machine. Due to the embodiment according to the present invention, however, the power which may be provided by the electric machine may still be additively available. In other words, a power adjustment up to the Mdₘₐₓ curve in the direction of reducing consumption may readily be carried out without any fear of the internal combustion engine stalling during load changes, since the additional power of the electric machine is available for this case.

P1-P2 corresponds to the dynamic rotational speed reduction when the load (power) remains stationary. Dynamic deflection of joystick (20) (HMI signal) thus precisely dynamically increases the load for the consumer.

P2-P3 corresponds to the profile having the dynamic rotational speed reduction and assistance from the electric machine (2).

P2-P4 corresponds to the profile having the dynamic rotational speed reduction but without assistance from electric machine (2).

P1-P2 corresponds to the profile having an abrupt load change without dynamic rotational speed reduction.

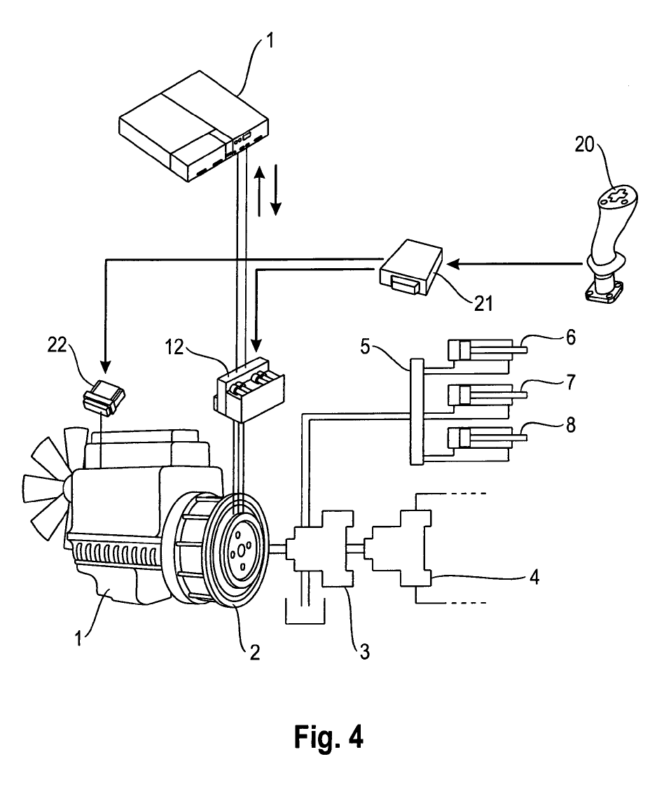

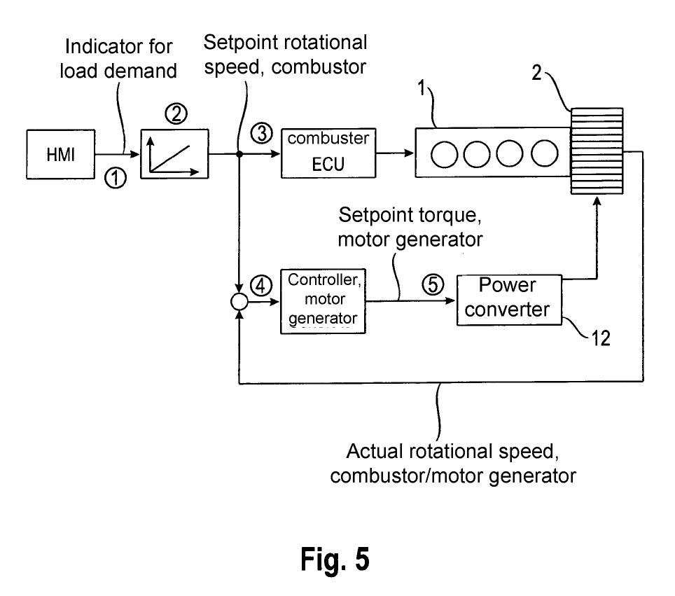

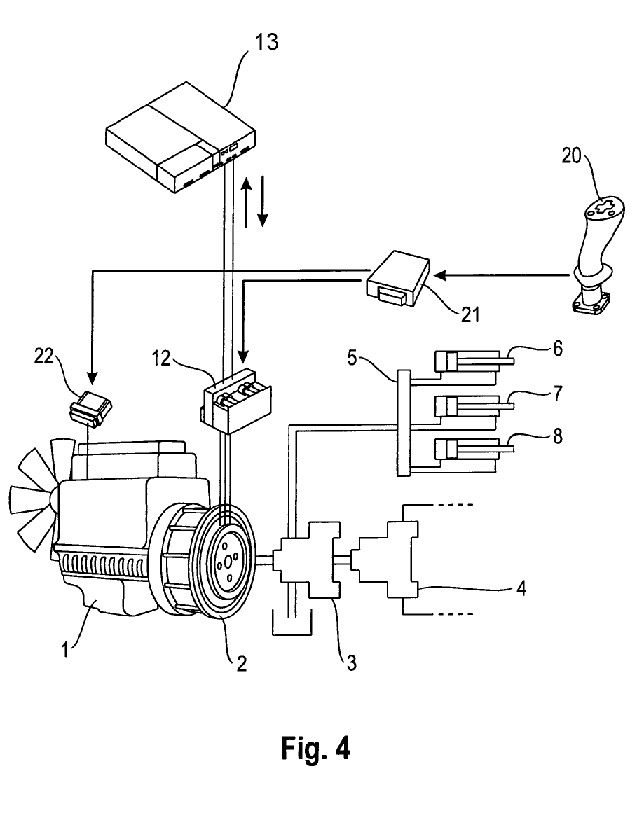

FIG. 4, in combination with FIG. 5, shows how the nominal rotational speed of the internal combustion engine of a construction machine may be highly dynamically accelerated during a working phase, despite dynamic load peaks. The internal combustion engine is expanded to a mild hybrid system for this purpose. The expansion includes an energy store 13 and an electric machine 2, which may be connected directly to the crankshaft as well as to a PTO (power takeoff). Electric machine 2, including associated energy store 13, may be provided with both an electric and a hydraulic design.

Electric machine 2 operates highly dynamically during the output or intake of energy, compared to internal combustion engine 1. Internal combustion engine 1 operates at a preferably low rotational speed during its working phases. In the case of load requests which demand a higher rotational speed of internal combustion engine 1, internal combustion engine 1 is assisted highly dynamically in parallel by electric machine 2 during the acceleration operation up to the higher setpoint rotational speed, e.g. in motor-driven operation of electric machine 2. The energy of electric machine 2 needed for this purpose comes from energy store 13. In phases of lower load demand, energy store 13 is recharged with the aid of electric machine 2, for example by the generator-driven operation of electric machine 2. The load demand must be detected as early as possible to be able to very quickly assist internal combustion engine 1 with the aid of electric machine 2 in the acceleration phase. This takes place the fastest by evaluating the signals of HMI interfaces 20, for example joystick 20, which is operated by the machine operator.

The required rotational speed of internal combustion engine 1—the nominal rotational speed—is ascertained with the aid of the ascertained load demand. This rotational speed is set via the control unit 22 of internal combustion engine 1. While internal combustion engine 1 now already tries to accelerate to the new nominal rotational speed on its own, it is assisted by electric machine 2 via a highly dynamic torque buildup. The setpoint torque of electric machine 2 is ascertained from the difference between the nominal and actual rotational speed.

The nominal rotational speed of internal combustion engine 1 is ascertained by evaluating HMI interfaces 20; a dynamic rotational speed reduction of internal combustion engine 1 in a construction machine with the aid of electric machine 2 is utilized. Electric machine 2 of the mild hybrid drive assists internal combustion engine 1 highly dynamically during the acceleration phases up to the desired higher nominal rotational speed. Electric machine 2 is connected directly to the crankshaft or to a PTO.

Electric machine 2, including its energy store 13, may be provided with both an electric and a hydraulic design. Batteries and/or capacitors and/or hydraulic stores may be considered for this purpose.

The method and the device are suitable, in principle, for all construction machines which are operated on the basis of the provision of power reserves upon dynamic load demands, presently at high nominal rotational speeds during the working phases. A special application takes place, for example, in a material handler.

The HMI signal is received by the hybrid control unit via the CAN bus; the transmission rate is in the range of approximately 10 m_{sec} or less.

The HMI signal represents, e.g. the deflection of a joystick 20 from left to right and is transmitted via the CAN as a signal having a value range from −100% to +100%.

All HMI signals which result in an increase in the load on the internal combustion engine are thus read out by the hybrid control unit.

All HMI signals are evaluated in hybrid control unit 21, and a setpoint rotational speed for internal combustion engine 1 is calculated therefrom. The evaluation takes place via characteristic maps and a weighting factor for each HMI signal.

If an HMI signal changes rapidly, a rapid change in setpoint rotational speed (3) in FIG. 5 also results.

This initially results in a great difference (4) in FIG. 5 between the setpoint and actual rotational speed of internal combustion engine 1, since internal combustion engine 1

a) is unable to follow the setpoint rotational speed quickly enough, due to the comparatively low momentum;
b) the rapid change in the HMI signal always means a rapid load increase for internal combustion engine 1, which counteracts a rapid adaptation of the actual rotational speed to the setpoint rotational speed.

The rotational speed difference is used to calculate the setpoint torque of electric machine 2-(5) in FIG. 5.

If the setpoint/actual rotational speed quickly becomes very high, the setpoint torque of electric machine 2 also quickly increases. In the event that the actual rotational speed is greater than the setpoint rotational speed, no torque is requested from electric machine 2.

### REFERENCE NUMERALS

1 internal combustion engine
2 electric machine
3 gear pump
4 axial piston pump
5 proportional valves
6 working cylinder
7 lifting cylinder
8 steering cylinder
9 axial piston motor
10 gear stage
11 driving wheels
12 four quadrant converter
13 energy store
20 human-machine interfaces (HMI), joystick
21 hybrid control unit (ECU)
22 control unit of the internal combustion engine (ECU)

1-10. (canceled)

11. A method for the dynamic rotational speed reduction of an internal combustion engine in a mobile working machine, aided by an electric machine, the method comprising:
ascertaining a nominal rotational speed of the internal combustion engine;
using, aided by the electric machine, a dynamic rotational speed reduction of the internal combustion engine, the electric machine assisting acceleration phases of the internal combustion engine from lower rotational speeds to higher rotational speeds.

12. The method as recited in claim 11 wherein the ascertaining of the nominal rotational speed takes place by evaluating human machine interfaces.

13. A hybrid drive train for a mobile working comprising:
an internal combustion engine;
an electric machine;
a hydraulic working machine; and
a control unit configured for ascertaining a nominal rotational speed of the internal combustion engine, the hybrid drive train being configured to, aided by the electric machine, use a dynamic rotational speed reduction of the internal combustion engine, the electric machine configured for assisting acceleration phases of the internal combustion engine from lower rotational speeds to higher rotational speeds.

14. The hybrid drive train as recited in claim 13 wherein the hydraulic working machine includes an axial piston pump configured for requesting power from the internal combustion engine or the electric machine.

15. The hybrid drive train as recited in claim 13 further comprising a hydraulic motor interconnected with the hydraulic working machine.

16. The hybrid drive train as recited in claim 15 wherein the hydraulic motor is an axial piston motor.

17. The hybrid drive train as claim 13 further comprising at least one hydraulic actuating element, a lifting cylinder and/or a steering cylinder interconnected with the hydraulic working machine.

18. The hybrid drive train as recited in claim 17 wherein the at least one hydraulic actuating element is at least one working cylinder.

19. The hybrid drive train as recited in claim 17 wherein the at least one hydraulic actuating element, the lifting cylinder and/or the steering cylinder is interconnected with the hydraulic working machine via one or multiple proportional valves.

20. The hybrid drive train as recited in claim 13 wherein the drive train is configured for operating in a rotational speed-regulated manner.

21. The hybrid drive train as recited claim 13 wherein the hybrid drive train is controllable in the manner that a load point shift is settable at the internal combustion engine.

22. The hybrid drive train as recited claim 13 wherein the hybrid drive train is configured such that a load point shift up to the range of reaching the maximum torque of the internal combustion engine takes place, and the electric machine is then motor-driven.

23. The hybrid drive train as recited claim 13 wherein the electric machine is a mild hybrid drive.
